(19) United States
(12) Patent Application Publication
(10) Pub. No.: US 2008/0171474 A1
(43) Pub. Date: Jul. 17, 2008

(54) High Density Interconnection Device With Dielectric Coating

(75) Inventors: Ralph Thomas, Bridgewater, MA (US); Raymond A. Frechette, N. Providence, RI (US)

Correspondence Address: DARBY & DARBY P.C., P.O. BOX 770, Church Street Station, New York, NY, 10008-0770, US

(73) Assignee: INTERPLEX NAS, INC., College Point, NY (US)

(21) Appl. No.: 11/908,657

(22) PCT Filed: Mar. 17, 2006
(86) PCT No.: PCT/US2006/009795

§ 371 Date: Sep. 17, 2007

Related U.S. Application Data
(60) Provisional application No. 60/662,619, filed on Mar. 17, 2005.

(51) Int. Cl. H01R 24/00

(52) U.S. Cl. 439/626; 29/592.1

(57) ABSTRACT

A high-density interconnection device or connector (1) that is formed with wafer in a stacked arrangement. The stack of wafers (20) is arranged to include signal wafers (20b) that alternate with shield wafers (20a). A dielectric coating (40) is applied to at least one body surface of one or more of the wafer to prevent electrical bridging between the adjacent signal and shield wafers (20a, 20b), e.g. when conductive debris is lodged between the wafers (20).

### TECHNICAL FIELD

The present invention relates generally to high density interconnection devices and more specifically to a high density interconnection device provided with a dielectric coating.

### BACKGROUND

It is known to use dielectric spacers in high density connector assemblies to provide insulation between terminals. U.S. Pat. No. 6,805,587 to Hazelton et al., the contents of which are incorporated herein by reference, discloses a dielectric spacer disposed on the terminals of a high density connector assembly. The connector assembly connects two circuit boards using mating connectors, such as a plug connector connected to one circuit board and a receptacle connector connected to the other circuit board. Each of the connectors includes a plurality of conductive terminals arranged in distinct sets for mating with corresponding terminals of the mating connector. Each set of terminals is separated by a discrete dielectric spacer so that each spacer insulates each set of terminals from adjacent sets. These spacers are bulky, are used only to separate adjacent terminal sets, and are not provided in the body of the connector.

It is known to use dielectric coatings to coat the terminals of a connector in order to provide insulation between terminals. U.S. Pat. No. 6,478,586 to Ma, the contents of which are incorporated herein by reference, discloses a dielectric coating provided on the conductive terminals of an electrical connector. The electrical connector includes a plurality of conductive terminals. Each terminal includes a contact surface on one end of the terminal that is adapted for connecting to a circuit board and another contact surface on the opposite end of the terminal for connecting to a corresponding terminal of a mating connector. Each of the conductive terminals is provided with a dielectric coating at a middle portion between these contact surfaces. The dielectric coating insulates each of the conductive terminals from adjacent terminals while the contact surfaces remain exposed. These dielectric coatings are used only to separate adjacent conductive terminals and are not provided in the body of the connector.

It is known to layer conductive coatings on top of dielectric coatings provided on a circuit board. U.S. Pat. No. 6,596,937 and No. 6,600,101 to Mazurkiewicz, U.S. Patent Application Publication No. 2004/0022003 to Mazurkiewicz, and U.S. Patent Application Publication No. 2002/0129951 to Babb et al., the contents of which are collectively incorporated herein by reference, disclose an electromagnetic interference (EMI) shield that includes a conductive coating and a dielectric coating that are bonded to each other. The dielectric coating is applied directly to the surfaces of a printed circuit board, and the conductive coating is applied directly on top of the dielectric coating. This two-layer EMI shield conformingly adheres directly to the surfaces of the circuit board and includes a dielectric coating that is bonded to a conductive coating.

What has heretofore not been available is a shield for a high density interconnection device that includes a plurality of wafers (row of terminals) in a stacked arrangement wherein a coating having a single layer of a dielectric material is applied directly to one or more wafer surfaces of the high density interconnection device.

### SUMMARY OF THE INVENTION

The present invention relates to a high density interconnection device, or connector, that is formed with wafers in a stacked arrangement. The stack of wafers is arranged to include signal wafers that alternate with shield wafers.

A dielectric coating is applied to at least one body surface of one or more of the wafers to prevent electrical bridging between the adjacent signal and shield wafers, e.g., when conductive debris is lodged between the wafers. The thickness of the dielectric coating can generally range from about 0.0001″ (0.0025 mm) to about 0.06″ (1.5 mm). The dielectric coating can also be used to eliminate or minimize inter-wafer electrical interference.

The dielectric coating is applied to the non-contact portions of the wafer and therefore is not applied to the contact portions, which are the functional portions of the wafer that directly contact another connector or a printed circuit board. The dielectric coating can be in a liquid, paste, or gel form, including, but not limited to, a dielectric ink or a non-conductive paint coating. Exemplary methods for applying the dielectric coating include, but are not limited to, printing (screen printing, silk screen printing, pad printing), painting, roll transferring, spraying, brushing, and applying a dielectric high performance tape.

The dielectric coating can be applied to the wafers in a continuous reel-to-reel configuration, which is usually done via automated equipment, or alternatively, the dielectric coating can be applied to individual loose wafers.

### BRIEF DESCRIPTION OF THE DRAWINGS

The foregoing and other features of the present invention will be more readily apparent from the following detailed description and drawings of the illustrative embodiments of the invention wherein like reference numbers refer to similar elements and in which:

FIG. 1 is a perspective view of the interconnection device according to an embodiment of the present invention;

FIG. 2 is a perspective view of a reel on which a continuous carrier strip that can be singulated into individual wafers that are used to form the interconnection device is wound according to an embodiment of the present invention;

FIG. 3 is a plan view of a signal wafer according to an embodiment of the present invention;

FIG. 4 is a plan view of a shield wafer according to an embodiment of the present invention; and

FIG. 5 is a plan view of an unwound carrier strip before being singulated into individual wafers to form the interconnection device of FIG. 1 according to an embodiment of the present invention.

### DETAILED DESCRIPTION OF THE PREFERRED EMBODIMENTS

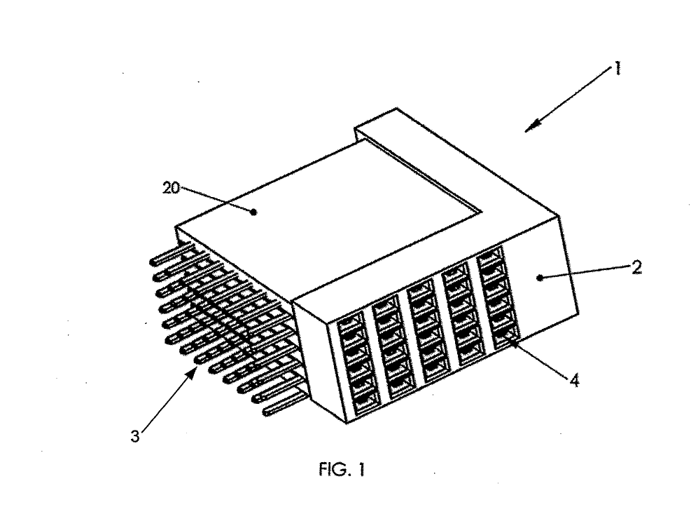

FIG. 1 illustrates a high density interconnection device, or connector 1, in accordance with an embodiment of the present invention, which is used to connect two circuit boards (not shown) together via a mating connector (not shown). One of the two connectors is a “plug” connector and the other is a “receptacle” connector. The connector shown in FIG. 1 is termed the receptacle connector because it receives the plug connector. It is to be understood that the plug connector is formed using a similar method that is used to form the receptacle connector as described herein.

The connector 1 has a housing 2, a mounting portion 3, and a mating portion 4. The housing 2 can be a molded or extruded plastic housing. The mounting portion 3 can include solder legs or connector leads that mount or are wave soldered to the circuit board. The mating portion 4 can include receptacle contacts that are stitched or inserted into holes of the housing 2 to mate with a mating portion of the plug connector.

The connector 1 also includes a series of components 20 that are referred to herein as “wafers” because of their relatively thin configuration. These wafers 20 are assembled into a stack, or block, of parallel wafers, which are maintained together by the housing 2.

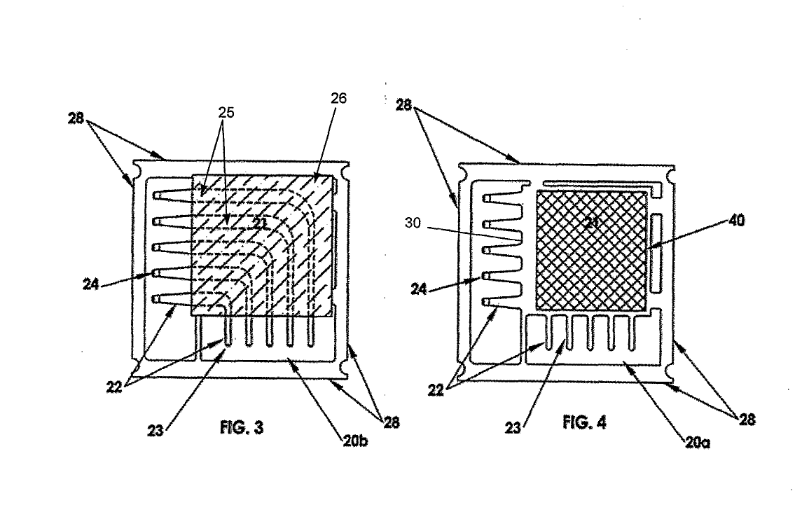

The wafers 20 are each formed as a generally flat plate with a central region 21 (FIG. 3) and terminals 22 that carry electrical signals or ground reference signals. The connector 1 of the present invention has a pitch of 2 mm or less, which means that the wafers 20 in the connector 1 are spaced no more than approximately every 2 mm. Tail or solder leg portions 23 of the terminals 22 form the mounting portion 3 of the connector 1 and are received within corresponding mounting holes formed in the circuit board. Receptacle contacts or contact portions 24 of the terminals 22 form the mating portion 4 of the connector 1 and are positioned to receive a plug from the corresponding plug connector (not shown). Other means of mounting can also be provided, as is well known in the art.

The wafers 20 can be assembled together in groups and preferably in pairs in order to effect signal transmission. Each pair of wafers includes a shield (ground) wafer 20a and a signal wafer 20b so that the wafers are arranged in alternating fashion, i.e., shield wafer—signal wafer—shield wafer—signal wafer—shield wafer—etc., where the ground reference terminals are parallel to the signal terminals in a vertical stacked arrangement. In this manner, the shield wafer 20a acts as an interstitial ground that is sandwiched between two signal wafers 20b to provide shielding between the signal wafers 20b.

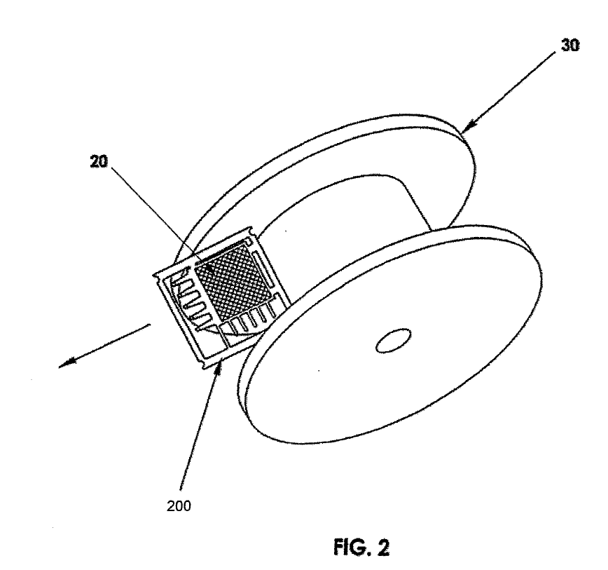

FIG. 2 illustrates a reel 30 and the wafers 20, which are connected by a common carrier strip 200, such that the wafers 20 are wound around the reel 30 in accordance with an embodiment of the present invention. The wafers 20 are formed and attached to a carrier strip 200 which is wound onto the reel 30, such that the wafers can be removed from the carrier strip and the carrier strip discarded.

FIG. 2 shows an end wafer 20 that is available to be removed from the reel 30 to form a connector such as the connector 1 shown in FIG. 1. FIGS. 3 and 4 illustrate a signal wafer 20b and a shield wafer 20a, respectively, which are constructed in accordance with an embodiment of the present invention.

The wafers 20 can include latches, mechanical fasteners, or retention features that aid in holding the wafer 20 to the housing 2.

The wafers 20 shown in FIGS. 2-5 also include links 28 that allow adjacent wafers 20 to form a single continuous carrier strip. These links 28 can be removed during the finishing process before assembling the connector 1.

The signal wafer 20b of FIG. 3 includes terminals 22 that may be formed, stamped, and plated. The tail portion 23 (e.g., tin-lead legs) of the terminal 22 projects from one edge 30 of the wafer 20b for mounting to the circuit board. The contact portion 24 (e.g., gold receptacle contacts) of the terminal 22 projects from another edge 30 of the wafer 20b for mating with an opposing contact of the plug connector. The two tail and contact portions 23, 24 are interconnected by intervening electrical pathways 25, which define an electrical path through the central region 21 of the wafer 20b between the contact portions 24 and the tail portions 23 of the terminals 22. The electrical pathways 25 can be formed on one or both sides of the signal wafer 20b. The electrical pathways 25 can be symmetrical on both sides of the signal wafer 20b.

A housing portion 26, which is preferably of an insulative and/or dielectric material, such as plastic or rubber, is formed about the electrical pathways 25 of the terminals 22 of the signal wafer 20b, e.g., by overmolding, insert molding, or another suitable technique. An example of the housing portion 26, also referred to as an overmolding 26, is shown in FIG. 3. The overmolding 26 covers a portion of the central region 21 of wafer 20b and can include voids or openings which are used to locate certain features in the subsequent manufacturing processes.

The shield wafer 20a is formed in a similar fashion to the signal wafer 20b except that it is not overmolded. The shield wafer 20a (FIG. 4) can have one or more terminals 22 that can be formed, stamped, and plated. The terminal(s) 22 can include one or more of the tail portions 23, one or more of the contact portions 24, and/or one or more of the electrical pathways 25 connecting the tail portions 23 to the contact portions 24. The tail portion 23 (e.g., one or more tin-lead legs) of the terminal 22 projects from one edge 30 of the wafer 20a for mounting to the circuit board. The contact portion 24 (e.g., gold contacts) of the terminal 22 projects from another edge 30 of the wafer 20a for mating with an opposing contact of the plug connector. Thus, the tail portion 23 connects to the circuit board and the contact portion 24 connects to the opposite connector.

A dielectric coating 40 is applied to at least one side of the shield wafer 20a. Optionally, the shield wafer 20a may be cleaned before applying the coating 40. Also, the shield wafers 20a may be plated before or after applying the dielectric coating 40. FIG. 3 illustrates a signal wafer 20b that is not yet plated, and FIG. 4 illustrates a shield wafer 20a that is not yet plated and that includes the dielectric coating 40.

When constructing a high density interconnection device, it is preferable to coat the shield wafer 20a on at least one side and not to coat the signal wafer 20b at all. Alternatively, depending on the intended application for the connector 1, the coating 40 can be applied to the signal wafer 20b only. The signal wafer 20b can be coated on the side on which the electrical pathways 25 are formed.

In another embodiment of the invention, the coating 40 can be applied to both the shield and signal wafers 20a, 20b depending on the spacing of the shield and signal wafers 20a, 20b, and on the method of holding the wafers 20 (signal and shield) in the housing 2. Therefore, a dielectric coating 40 can be provided on both the signal and shield wafers 20a, 20b in connectors 1 with a finer pitch. Both sides of both the signal and shield wafers 20b, 20a can be coated with the dielectric coating 40.

The shield wafer 20a can be coated on at least one of the sides that face the electrical pathways 25 of the signal wafer 20b, and the signal wafer 20b can be coated on the side on which the electrical pathways 25 are formed. In this embodiment, the signal wafer 20b and the shield wafer 20a are coated on their respective opposing body surfaces.

If the electrical pathways 25 are formed on both sides of the signal wafers 20b, then the shield wafers 20a can be coated on both sides so that both sides of the shield wafers 20a are insulated from the electrical pathways 25 on the opposing body surfaces of the adjacent signal wafers 20b.

The coating 40 can be applied to at least one of the sides of the shield wafer 20a that faces and is adjacent to the electrical pathways 25 of the signal wafer 20b that connect the contact portions 24 and the tail portions 23. The dielectric coating 40 acts as an insulator between the adjacent shield and signal wafers 20a, 20b.

Therefore, if at least one of the body surfaces of the shield wafer 20a is coated, then the signal wafer 20b can be coated with the dielectric coating 40 on zero, one, or two sides, depending on various factors such as the intended purpose of the connector 1. Alternatively, if at least one of the body surfaces of the signal wafer 20b is coated, then the shield wafer 20a can be coated with the dielectric coating 40 on zero, one, or two sides, depending on various factors such as the intended purpose of the-connector 1.

There is a risk of failure when conductive debris bridges the shield wafer 20a and any exposed area, i.e., any area that is not overmolded, in or around the overmolded portion of the signal wafer 20b. Therefore, the coating 40 can be applied to cover the area of the shield wafer 20a that is adjacent to the overmolded portion of the signal wafer 20b, particularly near the exposed areas in or around the overmolding 26 in which conductive debris may build up or become lodged.

There is a small gap of air between the signal wafer 20b and the shield wafer 20a. When conductive debris is caught between the adjacent signal and shield wafers so that the debris contacts both wafers, there is a risk of failure of the connector 1. The dielectric coating 40 helps to prevent this failure.

The coating 40 can be selectively applied and is not applied near any latches, mechanical fasteners, or retention features that aid in holding the wafer 20 to the housing 2. Depositing of the coating 40 on or near these features can result in splattering or build-up that can potentially lodge in areas in which an insulative or dielectric coating is unwanted, such as the contact portions 24 and the tail portions 23, which mate with the circuit board and mating connector, respectively.

In the illustrated embodiment of the present invention, the shield wafer 20a is not overmolded. Alternatively, the shield wafer 20a can be overmolded and then coated. As also mentioned above, the signal wafer 20b is usually overmolded, since it provides multiple connections via separate terminals (leads) 22 with terminal ends 23, 24. However, it is conceivable to forego overmolding the signal wafer 20b in favor of utilizing a dielectric coating on the signal and/or shield wafers.

The dielectric coating can be in a liquid, paste, powder or gel form, including, but not limited to, a dielectric ink or a non-conductive paint coating (e.g., non-conductive coatings described at http://www.kemcointernational.com/coatingspaint.htm, available from Kemco International Associates, Westlake, Ohio). Generally, a dielectric ink in liquid form achieves a thinner coating, which is desired in some applications, such as the high density interconnection device shown in FIG. 1. In other applications, a heavier thickness is desired for its increased dielectric properties, and a paste or gel form of dielectric coating is preferable. For example, a heavier thickness is preferable when the wafers 20, or portions thereof, are exposed, i.e., not overmolded and without any insulation jacket, and are in close proximity to each other in the connector 1.

The dielectric coating can include any type of dielectric material as a base material, such as a thermoplastic polymer or a polyacrylic ink. Alternatively, other materials can be included to enhance the dielectric properties, such as Teflon. The dielectric coating preferably has a composition that allows the coating to adhere sufficiently to the wafer and to be sufficiently durable and resistant to scratches. Other favorable properties include hardness and heat resistance. Heat resistance is preferable when the connector is subjected to heat during use or for standards ratings, such as UL or CSA.

The thickness of the dielectric coating can generally range from about 0.0001″ (0.0025 mm) to about 0.06″ (1.5 mm).

One example of a dielectric ink that is used in the present invention is ERCON E6155-116, available from Ercon Incorporated, Wareham, Mass., which is a solvent-based ink that is thermally cured. The thickness of this ink coating applied via screen printing can range from 0.0006″ (0.015 mm) to 0.0015″ (0.038 mm).

Another example of a dielectric ink used in the present invention is Creative Materials 116-20, available from Creative Materials Incorporated, Tyngsboro, Mass., which is solvent resistant, flexible, and ultraviolet cured. The thickness of this ink coating applied via screen printing can range from 0.0006″ (0.015 mm) to 0.0015″ (0.038 mm).

Exemplary methods for applying the dielectric coating include, but are not limited to, printing (screen printing, silk screen printing, pad printing), painting, roll transferring, spraying, brushing, and applying a dielectric high performance tape.

Silk screen printing allows the dielectric coating to be applied more quickly onto flat body surfaces. Therefore, this process is more suitable for reel-to-reel applications. A dielectric ink can be applied by silk screen printing. Applying a dielectric ink using this method is generally more cost effective than alternative methods, such as painting.

Pad printing is preferable when the dielectric coating is applied to formed body surfaces, i.e., when the body surface is not substantially flat. The ink thickness for pad printing can range between 0.0006″ (0.015 mm) and 0.0015″ (0.038 mm).

The coating 40 is applied to continuous surfaces on the wafer 20 that are not intended to be contact points, such as the contact and tail portions 24, 23 of the wafer 20. Therefore, the coating 40 is not applied to the contact portions 24 (gold-plated contacts) or the tail portions 23 (tin-plated terminal pins/solder tails). These conductive areas are plated and mate with the mating connector or circuit board. Applying the dielectric coating 40 to the non-contact points of the wafer 20 prevents the connector 1 from making an undesired electrical connection with any portion of the mating connector or circuit board.

The area of the shield wafer 20a on which the dielectric coating 40 is applied is indicated by shading in FIG. 4. The dielectric coating 40 is applied to substantially the entire central region 21 with exception to any latches, mechanical fasteners, or retention features, of the wafer 20a. The coated area can be a small, contoured area, e.g., a rectangular, round, or triangular area, for covering only the exposed potentially conductive areas of the shield wafer 20a, such as the areas adjacent to any voids or cavities in the overmolding 26 of the signal wafer 20b. The contact and tail portions 24, 23 (the gold plated contacts and the tin-lead/solder legs) are not coated with the dielectric coating 40.

As described above, the dielectric coating 40 can also be applied to the signal wafer 20b. In this case, the dielectric coating 40 can be applied to the same area as described above for the shield wafer 20a.

As shown in FIG. 4, the dielectric coating 40 can be applied to substantially the entire central region 21 of the wafer 20. Alternatively, the dielectric coating 40 can be applied to only a portion of the central region 21 of the wafer 20. The central region 21 of the wafer 20 can have features or openings and cut outs that may or may not require dielectric coating. Also, the dielectric coating 40 can be applied at a predetermined distance from the edges of the wafer 20 and/or from the edges of any features and openings or cut-outs in the central region 21. This predetermined distance depends on the coating process. Therefore, the coating 40 is limited to this selected portion of the central region 21 of the wafer 20 away from the edges of the wafer 20 and away from the edges of any other features or openings, thereby preventing the possibility that the coating 40 will splatter or that the coating 40 will be applied too close to the edges of the wafer 20. If the coating 40 is applied too close to the edges, the coating 40 may dry with loose pieces that could break off and lodge in other areas of the connector 1 and cause the connector 1 to fail to operate. Splattering may cause the coating 40 to adhere to the contact and tail portions 24, 23 of the wafer 20, thereby inhibiting the conductive ability of the contact and tail portions 24, 23. Therefore, the coating 40 is preferably applied as close to the edges as possible while minimizing the risk of splattering or forming loose pieces of debris.

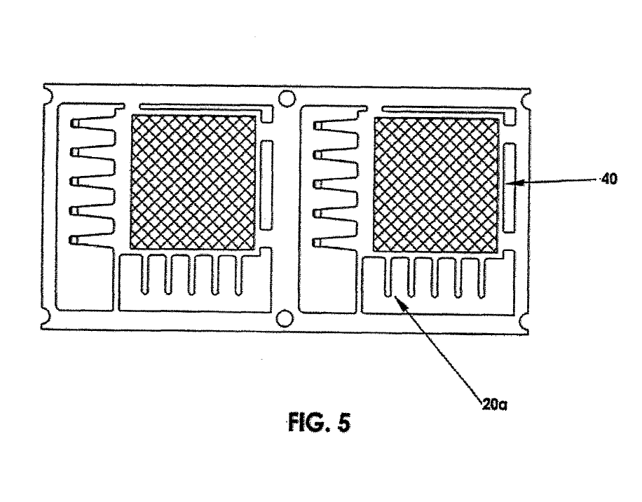

FIG. 5 shows a carrier strip of wafers 20 having a dielectric coating 40, and FIG. 2 shows the carrier strip of stamped parts (wafers) wound around the reel. The dielectric coating is applied to the wafers and is allowed to dry and/or is cured. Then, the carrier strip of wafers is fed to and wound onto another reel. This process is called a reel-to-reel process, and the wafers are packaged on the reel using this process.

After applying the coating 40, the tail portions 23 and the contact portions 24 of the wafers 20 may be plated before or after being wound onto another reel. The shield wafer can be plated in a separate reel-to-reel electroplating process. Alternatively, the shield wafer can be plated in a loose piece plating process. The wafers can be plated before applying the coating.

After the coating is applied, the coating is cured. Exemplary methods for curing the coating include ultraviolet (UV) curing, thermal curing, air curing, and epoxy curing, i.e., curing by chemical reaction. UV cured ink is generally more durable, more resistant to scratches, and is quicker to apply and cure. Also, fumes can be avoided with this method. Thus, UV cured ink is generally a more practical and economical method of curing than thermal cured ink and other types of coatings.

After curing the coating, the wafers are separated from the reel and assembled into the connector. After applying and curing the dielectric coating, the wafer can also be plated and/or overmolded prior to being separated from the continuous carrier strip.

The present invention provides a high density connector and shield assembly in which a dielectric coating is selectively applied, and the resulting connector includes wafers in a stacked arrangement wherein the coating is applied to at least one body surface of one of the wafers. The dielectric coating can be applied to the wafers in a continuous reel-to-reel configuration, which is usually done via automated equipment, or alternatively, the dielectric coating can be applied to individual loose wafers.

The connector of the present invention is very cost effective, especially when the dielectric coating is applied as an ink, rather than as dielectric high performance tape or some types of coating, such as painting, roll transferring, spraying, or brushing.

The wafers are formed for a particular standard in 2 mm pitch connectors. Alternatively, the dielectric coating of the present invention allows connectors to be designed with a much finer pitch so that the shield and signal wafer can be positioned closer together.

A selective insulating barrier coating is provided between the signal wafer and the adjacent shield wafer. Any bridging, inter-wafer electrical interference, or Dielectric Withstanding Voltage_(DWV) through conductive debris is minimized or eliminated between the signal and the shield wafers, thereby preventing product failure.

The dielectric coating is very thin, durable, and adheres to flat and contoured surfaces of the shield wafer. The dielectric coating can be applied in a reel-to-reel process and therefore easily incorporated into existing manufacturing processes for the connectors. Furthermore, the dielectric coating can be selectively applied using very tight tolerances for location and/or thickness.

Having described embodiments of the invention with reference to the accompanying drawings, it is to be understood that the invention is not limited to those precise embodiments, and that various changes and modifications may be effected therein by one skilled in the art without departing from the scope or spirit of the invention. It is the intention, therefore, to be limited only as indicated by the scope of the claims appended hereto.

We claim:

1. A high density interconnection device comprising:
a plurality of wafers inside the body of a connector, the plurality of wafers including at least one signal wafer, and at least one shield wafer adjacent the signal wafer;
each signal wafer comprising:
a first body surface;
a second body surface;
at least one edge located between the body surfaces; and
at least one terminal extending from the at least one edge;
each shield wafer comprising:
a first body surface;
a second body surface;
at least one edge located between the body surfaces; and
a dielectric coating disposed on at least one of the first body surface and second body surface such that the body surface with the dielectric coating is disposed adjacent the body surface of the signal wafer containing the at least one terminal.

2. The high density interconnection device of claim 1 wherein the at least one terminal is disposed on the first body surface of each signal wafer and the dielectric coating is disposed on the second body surface of each shield wafer.

3. The high density interconnection device of claim 1 wherein the at least one terminal is disposed on both body surfaces of each signal wafer and the dielectric coating is disposed on both body surfaces of each shield wafer.

4. The high density interconnection device of claim 1 wherein the dielectric coating is formed from a liquid, powder, tape or gel.

5. The high density interconnection device of claim 4 wherein the dielectric coating includes a dielectric ink.

6. The high density interconnection device of claim 1 wherein the dielectric coating is disposed on the central region of the wafer.

7. The high density interconnection device of claim 1 wherein the wafers are parallel.

8. A high density interconnection device comprising:
a plurality of wafers inside the body of a connector, the plurality of wafers including at least one signal wafer, and at least one shield wafer adjacent the signal wafer;
each signal wafer comprising:
a first body surface;
a second body surface;
at least one edge located between the body surfaces;
at least one terminal extending from the at least one edge; and
a dielectric coating disposed on the body surface with the at least one terminal, the dielectric coating at least partially covering the at least one terminal, and
each shield wafer comprising:
a first body surface;
a second body surface;
at least one edge located between the body surfaces; and
a ground terminal extending from the at least one edge.

9. The high density interconnection device of claim 8 wherein the terminals are disposed on both the first and second body surface of the signal wafer.

10. The high density interconnection device of claim 8 wherein the dielectric coating is formed from a liquid, paste, powder, tape or gel.

11. The high density interconnection device of claim 10 wherein the dielectric coating includes a dielectric ink.

12. The high density interconnection device of claim 8, wherein the wafers are parallel.

13. A high density interconnection device comprising:
a plurality of wafers inside the body of a connector, the plurality of wafers including at least one signal wafer at least one shield wafer, with the signal and shield wafers arranged in alternating fashion,
each signal wafer comprising:
a first body surface;
a second body surface;
at least one edge located between the body surfaces and
at least one terminal extending from the at least one edge;
each shield wafer comprising:
a first body surface;
a second body surface;
at least one edge located between the body surfaces; and
a dielectric coating disposed on at least one of the first body surface and second body surface such that the body surface with the dielectric coating is disposed adjacent the body surface of the signal wafer containing the at least one terminal.

14. A method of making a high density interconnection device comprising the steps of:
providing at least one signal terminal on a body surface and extending from an edge of at least one of a plurality of wafers to produce at least one signal wafer,
providing a ground terminal on a body surface and extending from an edge of at least one other wafer to produce at least one shield wafer,
applying a dielectric coating to at least one body surface of said other wafer;
stacking the plurality of wafers such that the signal and shield wafers are arranged in alternating fashion; and
securing the plurality of wafers inside the body of a connector,
wherein a dielectric coating is disposed adjacent each signal terminal.

15. The method of claim 14 wherein the dielectric coating is applied on the shield wafer.

16. The method of claim 14 wherein the at least one signal terminal is provided on both body surfaces of the signal wafer.

17. The method of claim 14 wherein the dielectric coating is applied by printing.

18. A reel comprising:
a main body;
a carrier strip wound around the main body; and
a plurality of wafers disposed on the carrier strip, the wafers comprising:
two body surfaces;
at least one edge located between the two body surfaces and
at least one of:
a plurality of signal terminals extending from the at least one edge; and
a dielectric coating on at least one of the body surfaces.

19. The reel of claim 18 wherein the plurality of wafers include;
signal wafers having signal terminals on at least one body surface; and
shield wafers having a ground terminal and a dielectric coating on at least one body surface.
